(19) United States
(12) Patent Application Publication
(10) Pub. No.: US 2024/0159507 A1
(43) Pub. Date: May 16, 2024

(54) RULER HAVING TWO SLIDABLE PARTS

(71) Applicants: Takuro Kayanuma, Kanagawa Pref. (JP); Kohei Nishikawa, Tokyo (JP); Kensho Kaneko, Kanagawa Pref. (JP); Kouta Tsuyuki, Shizuoka Pref. (JP); Toa Kimura, Saitama Pref. (JP); Sari Tsuruta, Saitama Pref. (JP); Ayaka Sudo, Saitama Pref. (JP); Haruna Tomizawa, Tokyo (JP); Ai Kitamura, Tokyo (JP)

(72) Inventors: Takuro Kayanuma, Kanagawa Pref. (JP); Kohei Nishikawa, Tokyo (JP); Kensho Kaneko, Kanagawa Pref. (JP); Kouta Tsuyuki, Shizuoka Pref. (JP); Toa Kimura, Saitama Pref. (JP); Sari Tsuruta, Saitama Pref. (JP); Ayaka Sudo, Saitama Pref. (JP); Haruna Tomizawa, Tokyo (JP); Ai Kitamura, Tokyo (JP)

(21) Appl. No.: 18/419,582

(22) Filed: Jan. 23, 2024

(51) Int. Cl. G01B 3/04

(52) U.S. Cl. CPC G01B 3/04

(57) ABSTRACT

A ruler having two slidable parts includes a ruler body, which is formed in rectangular shaped, the ruler body having a first recess extending longitudinally on its top surface and a second recess extending longitudinally on its side surface, a hand stand having a wheel, which is coupled with the second recess of the ruler body, and a wrist stand, the wrist stand having a wrist rest portion, a support portion for supporting the wrist rest portion, a joint connecting the wrist rest portion and the support portion, and ground portions attached to the support portion, wherein the ground portions are grounded to the bottom of the first recess.

### BACKGROUND OF INVENTION

### 1. Field of the Invention

This invention has been made by the members of MIMURA Seminar, College of Law, Nihon, Univ. as a team. The present invention relates to a ruler, and more particularly to a ruler having two slidable parts, which is suitable for writing letters in the same straight line without staining hands.

### 2. Description of the Related Art

Conventional rulers are used for drawing straight lines and measuring lengths. When writing extremely large letters on plain material, for example, imitation paper, it is difficult to write the letters in a straight horizontal line without using a tool. Furthermore, the ink of the written characters may be adhered to the grounded part of the hand, and the lateral part of the hand from the little finger to the wrist may be stained.

### SUMMARY OF THE INVENTION

The purpose of this invention is twofold: to solve the above problems to prevent hands from getting dirty when writing letters, and to write letters in a straight horizontal line. The ruler having two slidable parts of the present invention includes a ruler body, which is formed in rectangular shaped, the ruler body having a first recess extending longitudinally on its top surface and a second recess extending longitudinally on its side surface, a hand stand having a wheel, which is coupled with the second recess of the ruler body, and a wrist stand, the wrist stand having a wrist rest portion, a support portion for supporting the wrist rest portion, a joint connecting the wrist rest portion and the support portion, and ground portions attached to the support portion, wherein the ground portions are grounded to the bottom of the first recess.

### BRIEF DESCRIPTION OF THE DRAWING

The invention will be more particularly described with reference to the accompanying drawings, in which:

FIG. 1 is a diagram of a ruler having two slidable parts according to the first preferred embodiment of the invention,

FIG. 2 is a rear view of the ruler having two slidable parts shown in FIG. 1,

FIG. 3 is a cross-sectional view between A-A′ of the main body of the ruler having two slidable parts shown in FIG. 1, representing its internal structure, and

FIG. 4 is a rear view of the hand rest part of the ruler having two slidable parts shown in FIG. 1.

### DETAILED DESCRIPTION OF THE PREFERRED EMBODIMENTS

The preferred embodiment of the invention as a ruler having two slidable parts is explained together with drawings as follows. In each drawing, the same reference numbers designate the same or similar components through all embodiments.

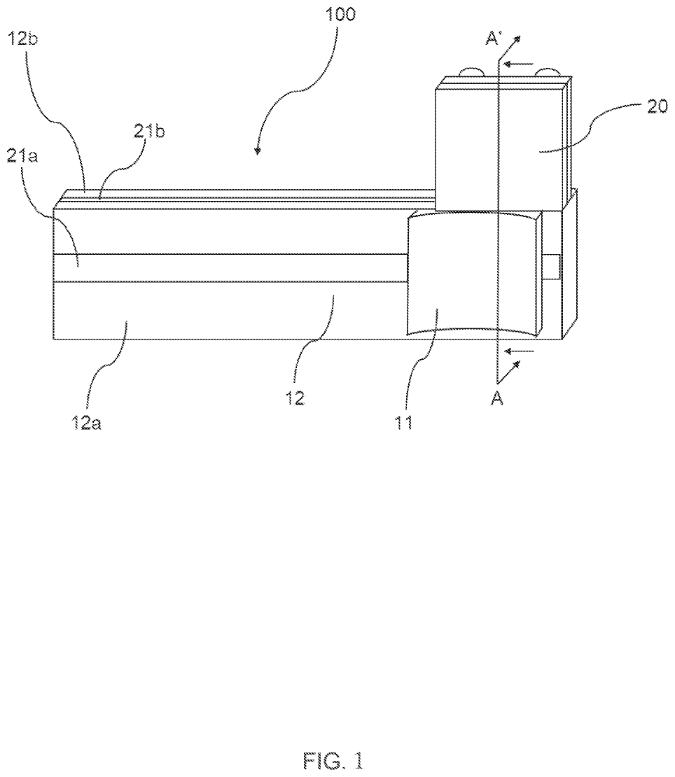

FIG. 1 shows a perspective view of a ruler having two slidable parts of the present invention. As shown in FIG. 1, a ruler having two slidable parts 100 includes a main body 12, a hand stand 20, and a wrist stand 11.

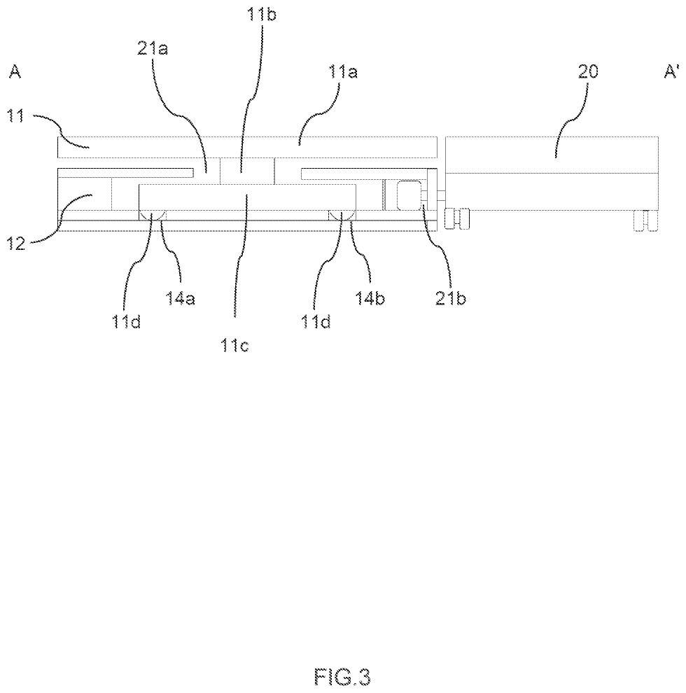

The main body 12, which is formed in a rectangular shape, a first surface 12a and a second surface 12b adjacent to the first surface 12a. A first horizontal recess 21a extending longitudinal direction is formed almost at the center of the first surface 12a, and a second horizontal recess 21b extending longitudinally is formed almost at the center of the second surface 12b. The cross-sectional shape of the first horizontal recess 21a cut at A-A′ will be described later using FIG. 3. Both of the first and second horizontal recesses 21a and 21b extend from one end to the other end of the first and second surfaces 12a, 12b, respectively.

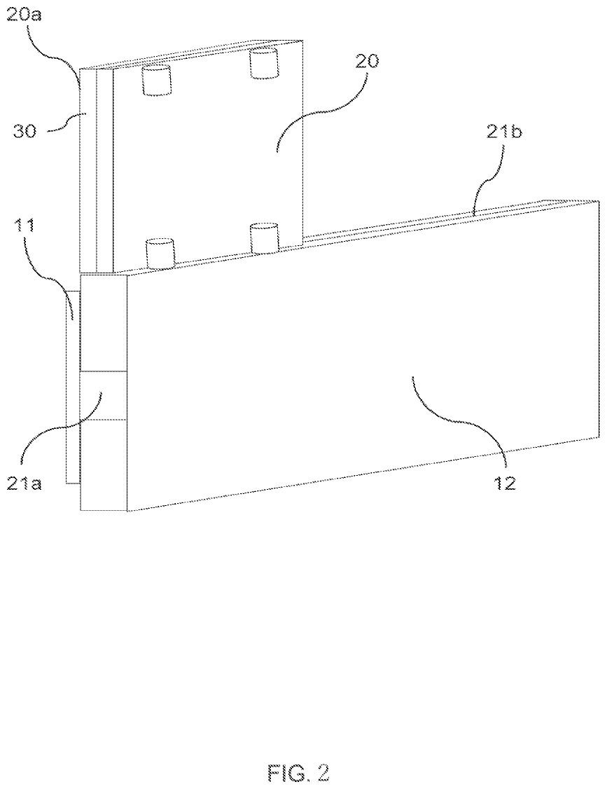

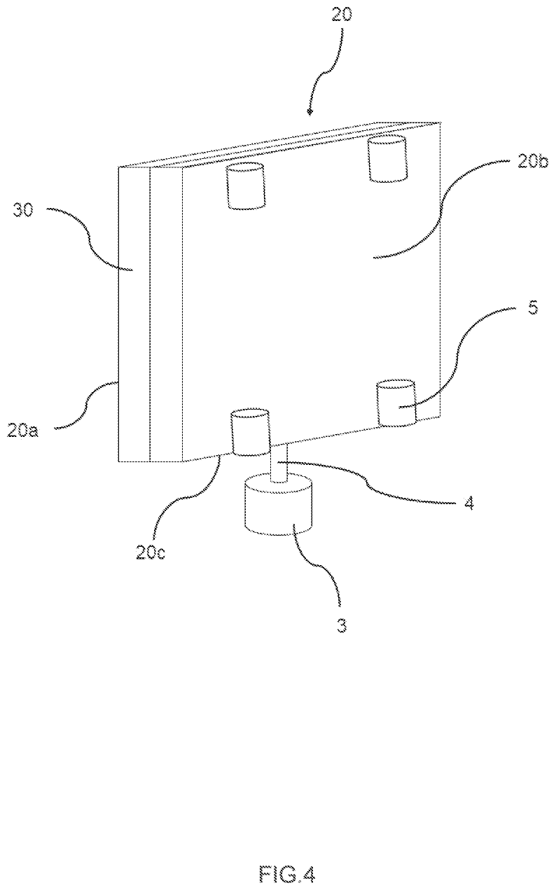

As shown in FIG. 2 and FIG. 4, the hand stand 20, which has a top surface 20a, a bottom surface 20b, and a side surface 20c, is formed in rectangular or cuboidal shape, and has four first wheels 5 formed on the bottom surface 20b. Each of the first wheel 5 is formed near a respective corner of the bottom surface 20b. All of the first wheels 5 are mounted to rotate in the same direction. In addition, the hand stand 20 includes singe second wheel 3 via a metal joint 4 approximately in the center of the side surface 20c.

The second wheel 3 is coupled in the second horizontal recess 21b, and the second wheel 3 rotates therein, so that the hand stand 20 can be moved in longitudinal direction the second surface 12b of the main body 12. The hand stand 20 includes a sponge-like anti-slip 30, which is made of polyurethane foam on its upper surface 20a in order to fit the user's hand shape. The lower part 32 of the hand stand 20 other than the anti-slip 30 is made of plastic material. It is preferable that the total thickness of the hand stand 20 be set to about 2 times the thickness of the anti-slip 30.

As shown in FIG. 3, the wrist stand 11, whose surface is curved, includes a wrist rest portion 11a and a support portion 11c, which is connected to the wrist rest portion 11a by a joint 11b. A plurality of hemispherical ground parts 11d are formed on the back surface of the support portion 11c in two rows, and are in contact with the bottom of the first horizontal recess 21a. The first horizontal recess 21a has a relatively narrow opening and a relatively wide interior region. Since the width of the support portion 11c is longer than the opening of the first horizontal recess 21a, the wrist stand 11 may not be dislocated from the main body 12 by inserting the support portion 11C from the edge of the main body 12 into the first horizontal recess 21a.

The main body 12 includes two grooves 14a and 14b in parallel in the longitudinal direction at its bottom in the first recess 21a. Each line of the ground parts 11d are located into one of grooves 14a, 14b, respectively. As described, since ground parts 11d are formed in hemispherical shape, the frictions of the ground parts 11d with the surface of the grooves 14a, 14b are reduced because the contact areas could be reduced.

According to the ruler having two slidable parts 100 of this invention, it is possible the wrist stand 11 is moved along the first horizontal recess 21a. When the user writes a letter using the ruler having two slidable parts 100, the wrist of the user needs to be fixed on the wrist stand 11. Thus, the wrist stand 11 needs to constrain the motion for a little time while writing the letter. On the other hand, to write a letter like “Z”, the user's hand needs to move to the left or right with some extent so the hand rest 20 needs to slide easily. Further, after finishing writing a letter, the arm of the user should be moved to write the next letter. According to the structure of the ruler having two slidable parts 100, the wrist can be held in place by the frictional force between the ground portions 11d and the surface of the grooves 14a, 14b for the period of writing one letter, while the hand of the user can move freely to the left or right. Moreover, the wrist stand 11 can be easily moved by releasing the friction between the ground portions 11d and the surface of the grooves 14a, 14b for the next letter being written.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention.

We claim:

1. A ruler comprising:
a ruler body, which is formed in rectangular shaped, the ruler body having a first recess extending longitudinally on its top surface and a second recess extending longitudinally on its side surface,
a hand stand having a wheel, which is coupled with the second recess of the ruler body, and
a wrist stand, the wrist stand having a wrist rest portion, a support portion for supporting the wrist rest portion, a joint connecting the wrist rest portion and the support portion, and ground portions attached to the support portion, wherein the ground portions are grounded to the bottom of the first recess.

2. A ruler according to claim 1, wherein the hand stand includes an upper part and lower part, wherein the ruler body, the lower part of the hand stand and the wrist stand are made of plastic, wherein the joint is made of metal, and wherein the upper part of the hand stand is formed from polyurethane foam.

3. A ruler according to claim 2, wherein the thickness of the hand stand is formed at 2 times that of the upper part of the hand stand.

4. A ruler according to claim 1, wherein each of the ground portions is formed in hemispherical shape.
